(19) United States
(12) Patent Application Publication
(10) Pub. No.: US 2017/0023122 A1
(43) Pub. Date: Jan. 26, 2017

(54) Axle for Rotatably Supporting a Gear or the Like

(71) Applicant: Christopher T. Cordingley, Los Angeles, CA (US)

(72) Inventor: Christopher T. Cordingley, Los Angeles, CA (US)

(21) Appl. No.: 15/288,030

(22) Filed: Oct. 7, 2016

Related U.S. Application Data
(63) Continuation-in-part of application No. 14/596,647, filed on Jan. 14, 2015.
Application No. 14/596,647 is a continuation-in-part of application No. 29/565,212, filed on May 18, 2016.

(51) Int. Cl. F16H 57/00

(52) U.S. Cl. CPC F16H 57/0031

(57) ABSTRACT

An axle for rotatably supporting a rotating object having a circular hole therein, such as a gear. The axle includes a shaft and an enlarged head having slits dividing the enlarged head into a plurality of sections, such as three. The enlarged head is tapered to enable pressing the rotating object thereagainst to deflect the sections inwardly, so that the rotating object passes over the enlarged head into encircling engagement with the shaft. The enlarged head is fabricated from a material sufficiently elastic to enable the three sections to be constricted to enable the rotating object to be slid past the enlarged head, and to be entrapped upon spontaneous expansion of the enlarged head when the rotating object has cleared the enlarged head.

### CROSS-REFERENCE TO RELATED APPLICATION

This application is a Non-Provision Utility Continuation-In-Part Application and claims the benefit of the filing date of U.S. Non-Provisional application Ser. No. 14/596,647 filed on Jan. 14, 2015, and also claims priority to U.S. Design patent application Ser. No. 29/565,212 filed on May 18, 2016, the contents of which are incorporated herein by reference.

### FIELD OF THE INVENTION

The present invention relates to spindle fasteners, or axles, for rotatably supporting gears.

### BACKGROUND OF THE INVENTION

The advent of three dimensional (3D) printing as a manufacturing technique now enables precision formation of small parts, such as gears. Gears must be rotatably held in their operative positions. This can be accomplished by spindles or axles secured to a three dimensionally printed gearset. It would be desirable to design axles to accept manual installation of 3D printed gears thereon.

Axles having bifurcated enlarged heads have been provided for this purpose. However, bifurcating an enlarged head may result in the head not being sufficiently compressible or deflectable, particularly along a straight bifurcation.

### SUMMARY OF THE INVENTION

The present invention addresses the above stated situation by providing an axle having greater radial compressibility than conventional bifurcated axles, while still being able to rotatably support a gear thereon. This results from dividing an enlarged head of an axle into three or more sections, rather than the traditional two.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a plan view of an assembly of abutting, mutually rotatable gears.

FIG. 2 is a perspective view of a frame on which the assembly of FIG. 1 is to be mounted.

FIG. 3 is an exploded perspective detail view of the gears of FIG. 1 spaced apart from their associated axles.

FIG. 4 is a side view of FIG. 3, also showing the frame of FIG. 2.

FIG. 5 is a bottom perspective view of the gears of FIG. 1 held in position by a support.

FIG. 6 is a top perspective view of FIG. 5.

FIG. 7 is a plan view of a final assembly wherein the gears of FIG. 1 are mounted on the frame of FIG. 2.

FIG. 8 is a block diagram summarizing steps of a method of fabricating the assembly of FIG. 7.

FIG. 9 is a perspective view of an axle for rotatably supporting a rotating member, according to at least one aspect of the invention.

FIG. 10 is atop plan view of the axle of FIG. 9.

### DETAILED DESCRIPTION

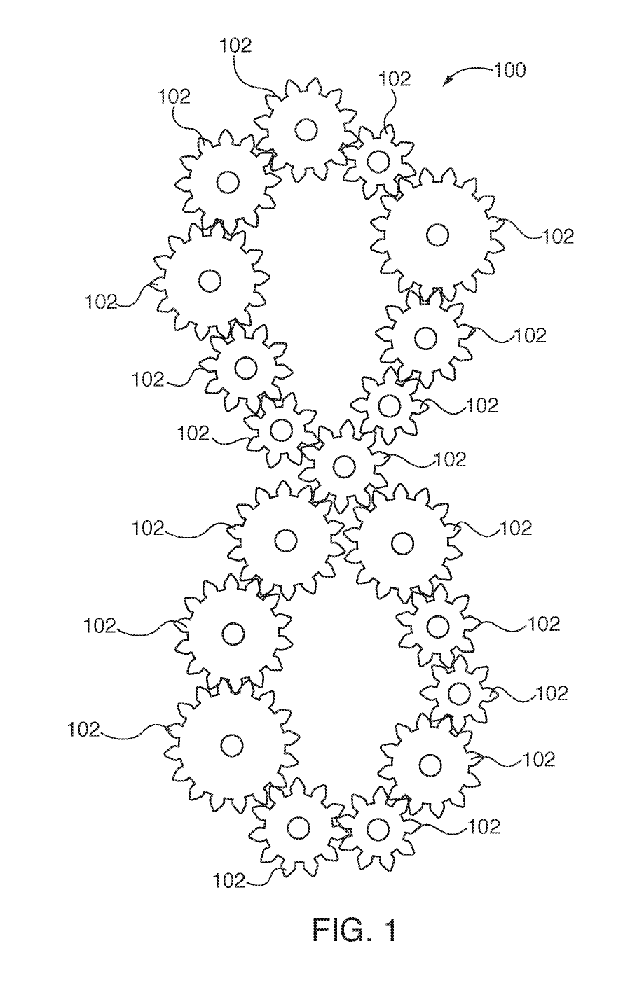

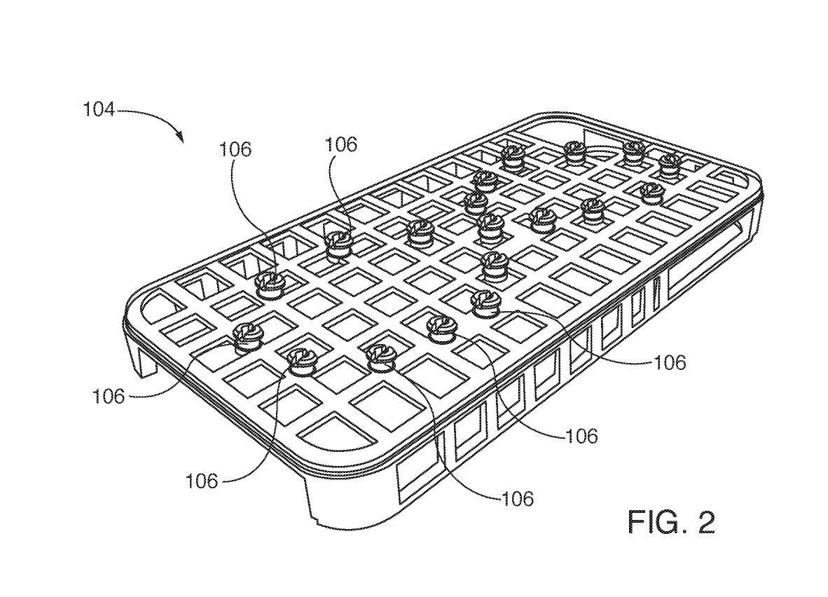

Referring first to FIG. 1, which shows an exemplary use of the present invention, there is shown an array 100 of abutting, mutually rotatable gears 102. FIG. 2 shows a frame 104 on which are mounted one or more axles 106. Each gear 102 is, in the final intended assembly 109 (see FIG. 7), to be mounted on one axle 106 such that the gears 102 will assume a configuration exemplified by the array 100. In the final intended assembly, the gears 102 are arranged on the axles 106 in the “figure-8” array depicted in FIG. 1. Each gear 102 will be able to rotate on its associated axle 106, and will be able to mesh with at least two abutting gears 102 as the gears 102 rotate on their associated axles 106. It would be impossible to manufacture the gears 102 in the desired “figure-8” array 100 by three dimensional printing in a conventional way because, since they abut one another, the gears 102 would be fused together in the three dimensional printing process.

Where an intended final assembly is made by 3D printing, the gears 102 may be three dimensionally printed simultaneously and held in a slightly spaced apart or expanded assembly. In this assembly, for final assembly to the frame 104, the gears 102 are mutually positioned as the array 100 (FIG. 1) which can be positioned over the frame 104 with each individual gear 102 centered vertically over its associated axle 106.

It should be noted at this point that orientational terms such as over, down, and below refer to the subject drawing as viewed by an observer. The drawing figures depict their subject matter in orientations of normal use, which could obviously change with changes in the way the depicted subject matter could be held by a person performing manufacturing or assembly, for example. Therefore, orientational terms must be understood to provide semantic basis for purposes of description only, and not in a limiting capacity.

The individual gears 102 can then be assembled to the frame 104 by dropping each gear 102 straight down, into engagement with its associated axle 106 below, and pressed onto the associated axle 106 into a final, operable position in which the gear 102 is supported on and can rotate about the associated axle 106.

It is the step of pressing each gear 102 down onto its associated axle 106 that is addressed by the present invention. Notably, the axle 106 is advantageously configured to enable this process to be readily performed manually.

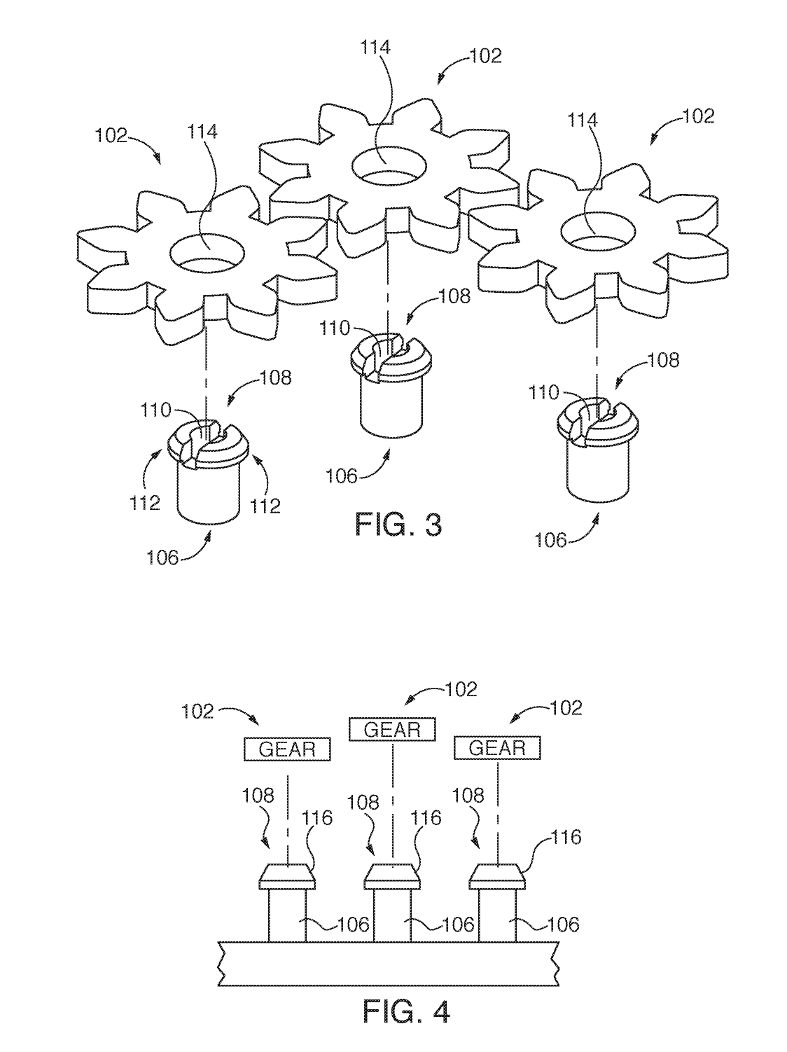

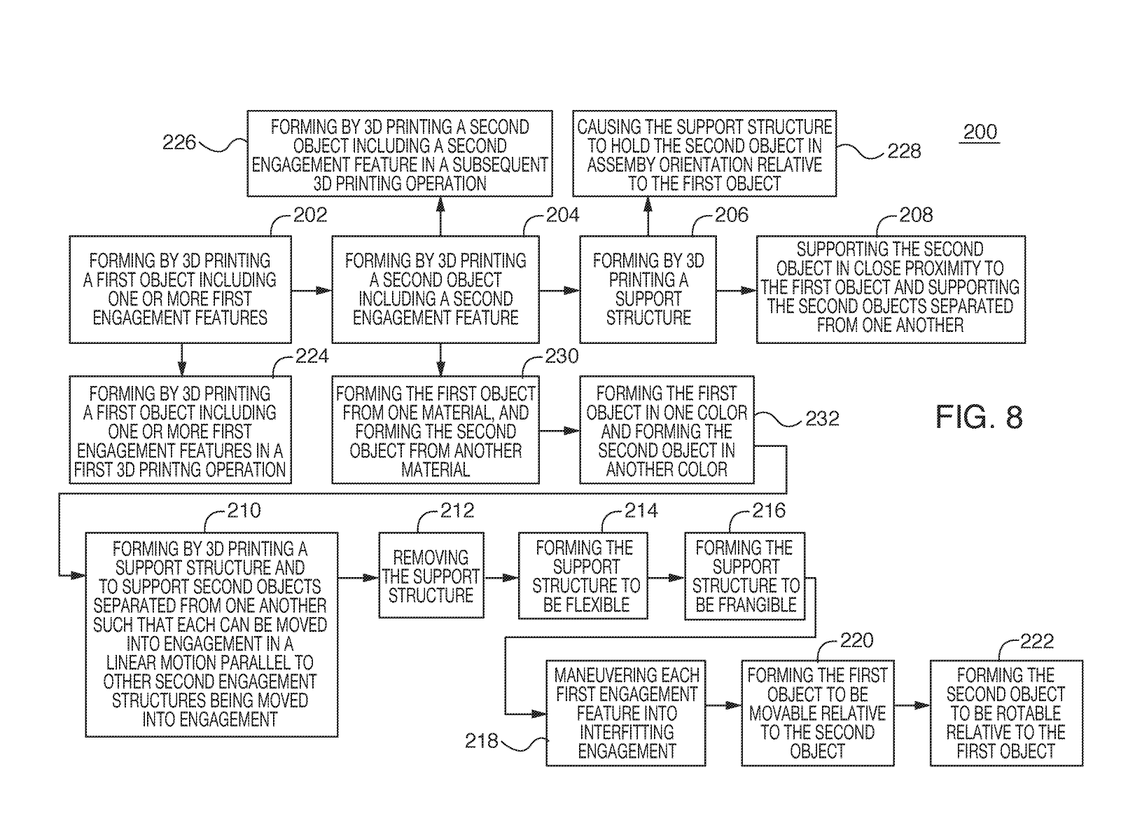

The array 100 may be achieved by a method 200 of forming an assembly by three dimensional printing, which in its most developed conception includes the following steps which are summarized in FIG. 8. The method 200 may include a step 202 of forming by three dimensional printing a first object such as the frame 104, the first object including one or more first engagement features such as the axles 106; and a step 204 of forming by three dimensional printing one or more second objects each of which includes a second engagement feature each of which complements one of the first engagement features of the first object such that interfit of the first object to the second objects is enabled. In the example of FIGS. 1-7, the second objects are the gears 102. The first engagement features of the first object are trifurcated enlarged heads 108 (FIGS. 3 and 4) which include an inclined surface 116 which accommodates insertion of the trifurcated enlarged heads 108 into corresponding holes 114 formed in each gear 102. The holes 114 of the gears 102 respectively provide the second engagement features and the second objects. The holes 114 of the gears 102 and the trifurcated enlarged heads 108 of the axles 106 complement one another to enable the interfit.

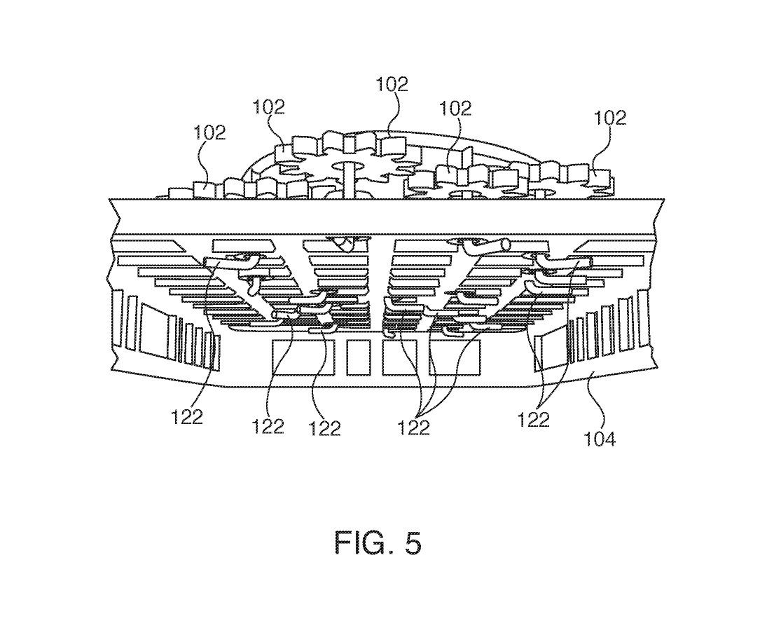

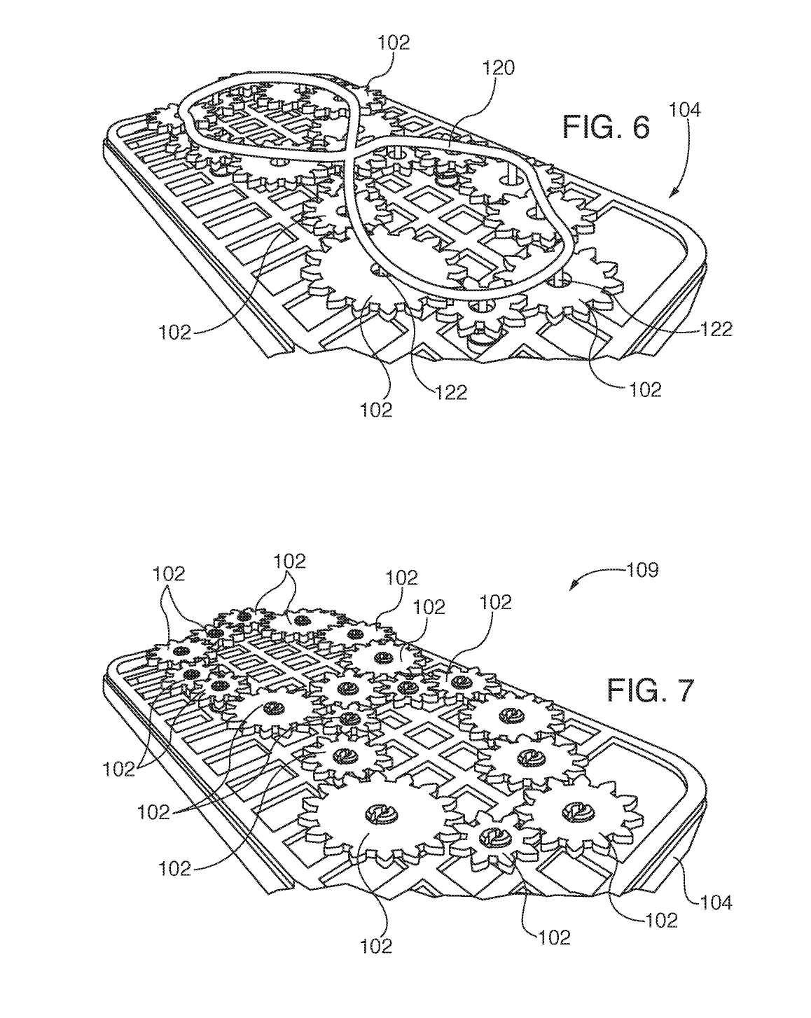

The method 200 further includes a step 206 of forming by three dimensional printing a support structure which is configured to engage the first object and to simultaneously support the second object such that the second engagement feature of the second object is supported in close proximity to the first engagement feature of the first object. In the example of FIGS. 1-7, and with particular reference to FIGS. 5 and 6, the support structure includes an upper member 120 from which depend a plurality of hooks 122. The hooks 122 pass through holes 110 (FIG. 3), each hole 110 formed in one of the gears 102. The hooks 122 hold the gears 102 immediately above their associated axles 106, but in vertically staggered positions so that each gear 102 is sufficiently separated from adjacent gears 102 so that three dimensional printing can fully form each gear 102 at the limits of resolution of the three dimensional printer (not shown) being used for fabrication. Therefore, the step 206 of the method 200 may further comprise a step 208 of supporting the second object in close proximity to the first object and supporting the second objects separated from one another such that the first object and the second object are dimensioned and configured about at the limits of resolution of a three dimensional printing apparatus.

FIG. 4 exemplifies vertically staggered positions of three gears 102, but with the support structure omitted from the view. Vertically staggered positions of several gears 102 can also be seen in FIG. 5. The gears 102 would be held proximate the frame 104, as shown in FIG. 6, by the hooks 122, which hooks 122 would pass through both the gears 102 and the axles 106, passing through the holes 110 of the axles 106. The hooks 122 terminate below the frame 104, so that the gears 102 and the frame 104 are entrapped between the upper member 120 and the hooks 122.

It should be noted that the steps 202, 204 may be performed simultaneously. That is, the frame 104 and the gears 102 may be three dimensionally printed simultaneously. Also, the steps 202 and 206 may be performed simultaneously. That is, the frame 104 and the support structure including the frame 104 and the hooks 122 may be three dimensionally printed simultaneously. Also, the steps 204 and 206 may be performed simultaneously. That is, the gears 102 and the support structure including the frame 104 and the hooks 122 may be three dimensionally printed simultaneously. Furthermore, all of the steps 202, 204, and 206 may be performed simultaneously.

The method 200 includes a step 210 of forming by three dimensional printing a support structure which is configured to engage the first object and to simultaneously support at least two of the second objects such that the second objects are separated from one another during three dimensional printing and in close proximity to the first object such that each one of the second engagement features can be moved into engagement with one of the first engagement features in a linear motion which is parallel to linear motions of every other one of the second engagement features being moved into engagement with one of the first engagement features. In the example of FIGS. 1-7, the support structure, which includes the upper member 120 and the hooks 122, engages the first object (e.g., the frame 104) and simultaneously supports the second objects (e.g., the one or more gears 102) immediately above the frame 104. The gears 102 are supported by the hooks 122 in close proximity just above and in vertical alignment with their associated axles 106. Vertical alignment is illustrated in FIG. 4 by dashed lines connecting each gear 102 to its associated axle 106. With the gears 102 supported in close proximity just above the axles 106, each gear 102 can be moved into engagement with one of the first engagement features (e.g., the enlarged head 108 of an axle 106) in a linear motion which is parallel to linear motions of every other one of the second engagement features being moved into engagement with one of the first engagement features (e.g., each gear 102 being moved straight down into engagement with an associated enlarged head of an associated axle 106).

With the gears 102 supported in vertical alignment with the axles 106 and in close proximity thereto, the gears 102 may be easily assembled to the axles 106. First, and as reflected in a step 212 of the method 200 of removing the support structure from the assembly including the frame 104, the axles 106 fixed to the frame 104, and the gears supported immediately above and in vertical alignment with the axles 106. The gears 102 are then free to drop by gravity towards their respective axles 106. This process may be performed manually. When the gears 102 contact the axles 106, each gear 102 may be maneuvered such that each trifurcated enlarged head 108 of an axle 106 penetrates a hole 114 of the gear 102.

The method 200 may include a step 214 of forming the support structure to be flexible. The hooks 122 in particular may be readily removed from the holes 110 of the axles 106 if they are flexible.

As an alternative to flexibility of the hooks 122 or of the entire support structure, the hooks or other portions of the support structure may be frangible. Therefore, even if rigid, the hooks 122 and other elements of the support structure may be removed by breaking off sections thereof. This is seen as a step 216 of the method 200, the step 216 further comprising forming the support structure to be frangible.

Bifurcation of the enlarged heads 108 of the axles 106 may generate two mirror image fingers to be defined. These mirror image fingers may display a slight degree of spring characteristics causing the enlarged heads 108 to expand within the holes 114, thereby retaining the gears 102 in engagement with their associated axles 106. The axles 106 may be sufficiently long and the enlarged heads 108 so configured that the enlarged heads 108 expand upon passing entirely through the holes 114, thereby positively entrapping the gears 102 in engagement with the axles 106.

The method 200 includes a step 218 of maneuvering each first engagement feature of the first object (e.g., each enlarged head 108 of each axle 106 mounted to the frame 104) into interfitting engagement with one second engagement feature of one second object (e.g., the hole 114 of a gear 102). The step 218 is accomplished by, for example, assembling the gears 102 to the enlarged heads 108 of the axles 106, as described hereinabove.

The method 200 includes a step 220 of forming the first object to be movable relative to the second object when the first engagement feature of the first object interfittingly engages the second engagement feature of the second object. The step 220 may further comprise a step 222 of forming the second object to be rotatable relative to the first object. Illustratively, the gears 102 may be formed at just a loose enough fit with the axles 106 so that they can rotate on the axles 106. In other examples (not shown), parts may be made which slide along one another, or which are otherwise relatively movable.

In the method 200, the step 202 of forming by three dimensional printing a first object including one or more first engagement features may comprise an optional step 224 forming by three dimensional printing a first object including one or more first engagement features in one three dimensional printing operation is performed in a first three dimensional printing operation. In this option, the step 204 of forming by three dimensional printing one or more second objects each of which includes a second engagement feature which complements one of the first engagement features of the first object such that interfit of the first object to the second objects is enabled, and the step 206 of forming by three dimensional printing a support structure which is configured to engage the first object and to simultaneously support the second object such that the second engagement feature of the second object is supported in close proximity to the first engagement feature of the first object are all performed in a single three dimensional printing operation. This is seen as optional step 226 in FIG. 8.

In the method 200, the step 206 of forming by three dimensional printing a support structure may comprise a further step 228 of causing the support structure to hold the second object in assembly orientation relative to the first object. Assembly orientation is an orientation or location of the second object relatively close to and in direct linear alignment with the first object. For example, in FIG. 4, all of the gears 102 are held directly above and in close proximity to their respective axles 106 simultaneously. In the example of FIG. 4, the gears 102 may be assembled expeditiously by pressing them onto their respective axles 106 by hand No effort is required to locate the gears 102 since they are held in assembly orientation by the support structure. After the gears 102 are pressed into engagement with their respective axles 106, the support structure can be broken away and discarded.

Where the first and second object are made in different three dimensional printing operations, the method 200 may comprise a further step 230 of forming the first object from one material, and forming the second object from another material. The step 230 may comprise a further step 232 of forming the first object in one color, and forming the second object in another color.

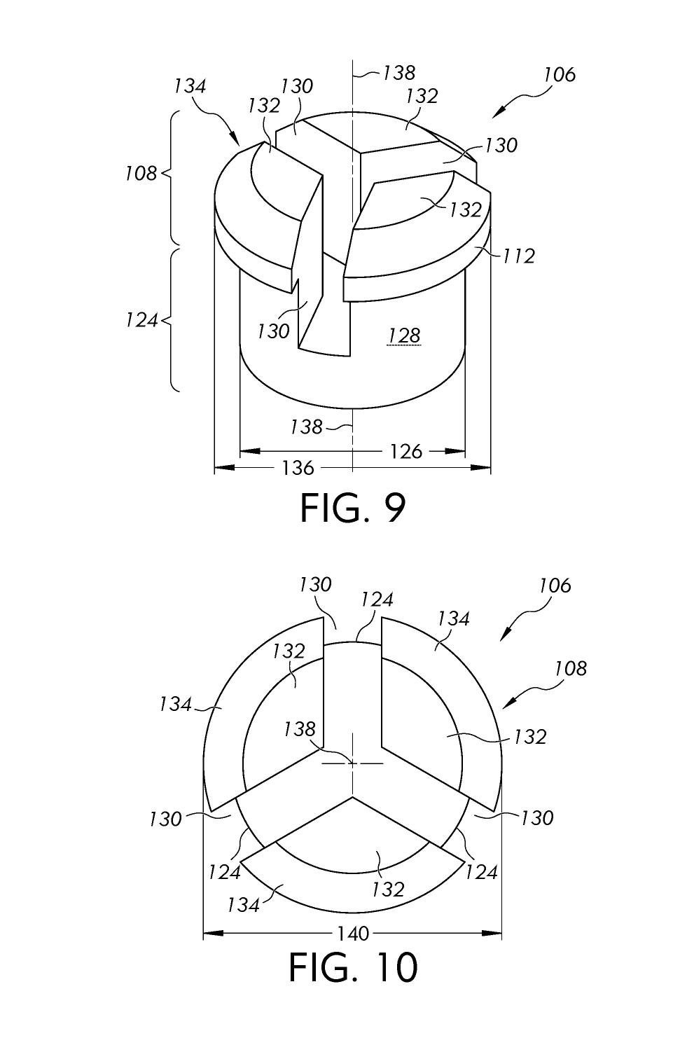

FIGS. 9 and 10 show one axle 106 for rotatably supporting a rotating object (e.g., a gear 102) having a circular hole (114, e.g., FIG. 3) therein. Axle 106 may comprise a shaft 124 having a first transverse dimension 126 and a periphery 128 configured to enable the rotating object to engage the shaft 124 by encirclement by the circular hole 114 (FIG. 3) and to be rotatably supported on the shaft 124. The axle 106 includes enlarged head 108 having a plurality of slits 130 dividing the enlarged head 108 into at least three sections 132. The enlarged head 108 has a tapered outer periphery or peripheral section 134 (FIG. 10) and a second transverse dimension 136 greater than the first transverse dimension 126 and the circular hole 114 of the rotating object (e.g., gear 102), so that the rotating object may be retained on the axle 106 by interference.

Axle 106 includes an axis 138 extending linearly through the shaft 124 and the enlarged head 108. The slits 130 extend into the shaft 124 and along the shaft 124 parallel to the axis 138. Slits 130 intersect one another, thereby enabling the overall periphery of the enlarged head 108 to be reduced when the at least three sections 132 are moved towards the axis 138.

The enlarged head 108 is fabricated from a material sufficiently elastic to enable the three sections 132 to be constricted to enable the rotating object (e.g., gear 102) to be slid past the enlarged head 108 and into encircling engagement with the shaft 124.

Gears 102 are shown in an initial position just above respective axles 106 in FIG. 3, and fully installed in FIG. 7. For purposes of understanding changes in the periphery of the enlarged head 108, the overall periphery may be represented by the second transverse dimension 136. This dimension obviously changes with constriction or compression, then rebound, of enlarged head 108. Many plastics will impart sufficient elasticity to accommodate constriction, and then to rebound spontaneously after the gear 102 has cleared the enlarged head 108.

The first transverse dimension 126 of the shaft 124 is a diameter when the shaft 124 is generally cylindrical, as depicted herein. It would be possible to make the shaft 124 depart somewhat from a substantially cylindrical shape (this option is not shown), provided that periphery 128 have sufficient surface area provided to enable gears 102 to rotate when installed on axles 106 as seen in FIG. 7.

The number of the sections 132 of the enlarged head 108 may be three. Although any number of sections 132 may be provided, three sections minimize complexity of fabrication. Provision of three sections 132 facilitate compression or alternatively stated, reduction of the periphery when pressing a gear 102 downwardly (as seen in FIG. 3) against the enlarged head 108 of an axle 106. In this sense, the periphery refers to the overall transverse dimension or diameter 140 (FIG. 10) of enlarged head 108. The sections 132 of the enlarged head 108 may be equal to one another in size and shape.

As used herein, a rotating object such as gear 102 has a capability or function related to rotation, but need not actually rotate at all times.

Continuing to refer principally to FIGS. 9 and 10, the shaft 124 may have, apart from the slits 130, a cylindrical configuration. Cylindrical configuration promotes rotation of a supported gear 102 with minimal play between the gear 102 and the shaft 124.

In the axle 106, the enlarged head 108 may be, apart from the slits 130, circular in cross section along the axis 138. The enlarged head 108 may have a tapered lateral portion or outer periphery 134 and, apart from the slits 130, a cylindrical portion 112.

The invention may be thought of not only as axle 106, but as also including a rotating object (e.g., gear 102) having a circular hole 114 therein. The circular hole 114 may have a diameter just greater in magnitude than every transverse dimension 126 of the shaft 124. The circular hole 114 may be of constant diameter along the extent thereof. The circular hole 114 may extend entirely through the rotating object. It would be possible to provide a blind circular hole 114, undercut to accommodate spontaneous expansion of enlarged head 108, if desired (this option is not shown). As has been mentioned, the rotating object may be the gear 102, a wheel, a control knob, an indicator needle, or other element which rotates at a fixed location.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An axle for rotatably supporting a rotating object having a circular hole therein, the axle comprising:
a shaft having a first transverse dimension and a periphery configured to enable the rotating object to engage the shaft by encirclement by the circular hole and to be rotatably supported on the shaft;
an enlarged head having a plurality of slits dividing the enlarged head into at least three sections, wherein the enlarged head has a tapered outer periphery and a second transverse dimension greater than the first transverse dimension and the circular hole of the rotating object, so that the rotating object may be retained on the axle by interference; and
an axis extending linearly through the shaft and the enlarged head, wherein
the slits extend into the shaft and along the shaft parallel to the axis, and intersect one another, thereby enabling the overall periphery of the enlarged head to be reduced when the at least three sections are moved towards the axis, and
the enlarged head is fabricated from a material sufficiently elastic to enable the three sections to be constricted to enable the rotating object to be slid past the enlarged head and into encircling engagement with the shaft.

2. The axle of claim 1, wherein the shaft has, apart from the slits, a cylindrical configuration.

3. The axle of claim 1, wherein the enlarged head is, apart from the slits, circular in cross section along the axis.

4. The axle of claim 1, wherein the enlarged head has a tapered lateral portion and, apart from the slits, a cylindrical portion.

5. The axle of claim 1, further comprising a rotating object having a circular hole therein, wherein the circular hole has a diameter just greater in magnitude than every transverse dimension of the shaft.

6. The axle of claim 5, wherein the circular hole is of constant diameter along the extent of the circular hole.

7. The axle of claim 5, wherein the rotating object is a gear.

8. The axle of claim 5, wherein the circular hole extends entirely through the rotating object.

9. The axle of claim 1, wherein the number of the sections of the enlarged head is three.

10. The axle of claim 9, wherein the sections of the enlarged head are equal to one another in size and shape.
